(19) United States
(12) Patent Application Publication
(10) Pub. No.: US 2010/0031579 A1
(43) Pub. Date: Feb. 11, 2010

(54) Protecting Device for Pushing of Sliding Door, Locking Device and Screen Door System

(76) Inventor: Kyung-Don Choi, Seoul (KR)

Correspondence Address: HARNESS, DICKEY & PIERCE, P.L.C., P.O. BOX 828, BLOOMFIELD HILLS, MI, 48303, US

(21) Appl. No.: 12/528,099

(22) PCT Filed: Feb. 29, 2008
(86) PCT No.: PCT/KR2008/001186

§ 371 Date: Aug. 21, 2009

(30) Foreign Application Priority Data
Mar. 3, 2007 (KR) 10-2007-0021219
Apr. 2, 2007 (KR) 10-2007-0032278
May 22, 2007 (KR) 10-2007-0049692
May 29, 2007 (KR) 10-2007-0052203
Jun. 29, 2007 (KR) 10-2007-0065449
Jul. 9, 2007 (KR) 10-2007-0068613
Jul. 18, 2007 (KR) 10-2007-0071595
Aug. 24, 2007 (KR) 10-2007-0085329
Nov. 13, 2007 (KR) 10-2007-0115378
Nov. 13, 2007 (KR) 10-2007-0115677
Dec. 21, 2007 (KR) 10-2007-0135456

(51) Int. Cl. E06B 3/00

(52) U.S. Cl. 49/503

(57) ABSTRACT

Provided is a door system including a door and a door sill. The door is coupled with a push-resistant device including a protruding plate hook. The door sill is coupled with a locking device. The push-resistant device is coupled and locked into the locking device when the door is closed.

### FIELD

The present invention relates to a push-resistant device and a locking device locking the push-resistant device, which are configured to prevent an elevator door or a platform screen door from being pushed perpendicular to the door.

### BACKGROUND

The present invention relates to a push-resistant device and a locking device locking the push-resistant device, which are configured to prevent an elevator door or a platform screen door from being pushed perpendicular to the door.

To prevent elevator doors and platform screen doors from being pulled toward a hoistway, Korean Patent Laid-Open Publication No. 10-2001-0000135, entitled “ELEVATOR DOOR FRAME AND METHOD OF CONSTRUCTING THE SAME” discloses a guide shoe in a lower portion of an elevator door. The guide shoe is movable in a groove of a guide rail forming a door sill.

FIG. 1 is a perspective view illustrating a door system provided to a related art elevator door.

Two floor doors 10 and 11, each having a panel shape, are disposed at an entrance of an elevator and configured to be closed or opened to an elevator cage that carries passengers up or down through a hoistway. When the elevator cage arrives and cage doors are opened or closed, the floor doors 10 and 11 are also opened or closed. When the elevator cage is moved or stopped at another floor, the floor doors 10 and 11 are closed to prevent accidental falls to the hoistway.

A floor door-driving unit 1 is disposed above the floor doors 10 and 11 and allows a wheel to move along a rail. The wheel is coupled to the floor doors 10 and 11. A door sill formed of aluminum protrudes from a floor toward the hoistway and is disposed below the floor doors 10 and 11. A guide rail 20 is coupled to the door sill. The guide rail 20 includes a groove 21 disposed in a longitudinal direction thereof. Guide shoes 30 are disposed on lower portions of the floor doors 10 and 11. Each of the guide shoes 30 includes a bracket and a plastic packet 31 surrounding a lower portion of the bracket. The bracket is coupled to the lower portion of the floor doors 10 and 11. The packets 31 are movable along the groove 21 of the guide rail 20 to guide movement of the floor doors 10 and 11. Also, the packets 31 serve as safety devices to prevent the floor doors 10 and 11 from being pushed away by a perpendicular force to the floor doors 10 and 11.

However, the packets 31 may not be fully inserted into the groove 21 when foreign objects are accumulated in the groove 21, or when the floor doors 10 and 11 are required to be smoothly moved along the groove 21. In this case, a limitation arises that the packets 31 cannot properly serve as safety devices.

That is, when an impact is exerted on the floor doors 10 and 11 from the floor toward the hoistway through which the elevator cage moves, the packets 31 may be released from the groove 21 and the floor doors 10 and 11 may be pushed toward the hoistway to cause an accident.

Although the aforementioned limitation arises in the floor doors of the entrance in the elevator, the same limitation arises in platform screen doors in subway stations.

Also, the limitation arises in the cage doors that are closed or opened for the elevator cage.

### SUMMARY

The present invention has been made in an effort to solve the above-described limitations of the related art. An object of the present invention is to provide a push-resistant device that can prevent a door including an elevator door from being pushed away when a force perpendicular to a moving direction of the door is exerted on the door.

To achieve the objects of the present invention, there is provided a door system including: a door on which a push-resistant device is disposed; and a guide rail on which a locking device coupled to the push-resistant device is disposed, the guide rail forming a guide sill for the door, wherein the push-resistant device includes a hook member protruding in a closing direction of the door, the locking device includes an upper surface and side surfaces bent downward from both sides of the upper surface, and the hook member is inserted into a space defined by the upper surface and the side surfaces when the door is closed.

According to another aspect of the present invention, there is provided a door system including: a door on which a push-resistant device is disposed; and a guide rail on which a locking device coupled to the push-resistant device is disposed, the guide rail forming a guide sill for the door, wherein the push-resistant device includes a hook member protruding in a closing direction of the door, the locking device includes an upper plate, a groove insertion portion protruding downward from a bottom of the upper plate and inserted into a groove disposed in a longitudinal direction of the guide rail, and a vertical portion bent downward from an end of the upper plate and disposed on an outer side of an outer wall of the guide rail, and the hook member is inserted and locked into a space defined by the upper plate, the vertical plate, and the outer side of the guide rail when the door is closed.

According to another aspect of the present invention, there is provided a door system including: a door on which a push-resistant device is disposed; and a guide rail on which a locking device coupled to the push-resistant device is disposed, the guide rail forming a guide sill for the door, wherein the push-resistant device includes a hook member protruding in a closing direction of the door and having an insertion opening in a front end thereof, the insertion opening is disposed in the closing direction of the door, the locking device includes a transverse member disposed perpendicular to a longitudinal direction of the guide rail, and the transverse member is inserted into the insertion opening when the door is closed.

According to another aspect of the present invention, there is provided a push-resistant device disposed on a door closed or opened along a guide rail forming a sill, the push-resistant device including: a coupling portion coupled to the door; a connecting portion bent from an end of the coupling portion and extended toward an outer side distant from the door; and a supporting portion extended downward from an end of the connecting portion and having a lower end parallel with an outer wall of the guide rail.

According to another aspect of the present invention, there is provided a door system including: a door on which a push-resistant device is disposed; and a guide rail on which a locking device coupled to the push-resistant device is disposed, the guide rail forming a guide sill for the door, wherein the locking device is disposed in a groove disposed in a longitudinal direction of the guide rail and includes a housing having an opening, the opening is disposed in a portion of an upper surface of the housing in the longitudinal direction of the guide rail, the push-resistant device includes a protruding portion protruding downward from a lower end of the door, and the protruding portion is inserted into the opening when the door is closed.

According to another aspect of the present invention, there is provided a door system including: a door on which a push-resistant device is disposed; and a guide rail on which a locking device coupled to the push-resistant device is disposed, the guide rail forming a guide sill for the door, wherein the push-resistant device includes a hook member protruding in a closing direction of the door, the locking device includes a horizontal portion covering a groove disposed in a longitudinal direction of the guide rail, and the hook member is inserted into a space defined by the groove and the horizontal portion when the door is closed.

According to another aspect of the present invention, there is provided a door system including: a door on which a push-resistant device is disposed; and a guide rail on which a locking device coupled to the push-resistant device is disposed, the guide rail forming a guide sill for the door, wherein the push-resistant device includes a hook member protruding in a closing direction of the door, the locking device includes: a moving stem vertically movable perpendicular to a bottom of a groove disposed in a longitudinal direction of the guide rail, the moving stem having a through hole through which a coupling bolt passing through the groove passes; and a cover disposed on an upper end of the moving stem for covering the groove, and the hook member is inserted into a space defined by the cover and the groove when the door is closed.

According to another aspect of the present invention, there is provided a locking device disposed on a guide rail forming a guide sill for a door including a lower end on which a push-resistant device including a hook member is disposed, the hook member protruding from the push-resistant device, the locking device being coupled to the hook member when the door is closed, the locking device including: a fixing bolt across a groove disposed in a longitudinal direction of the guide rail; and a pipe inserted into the groove of the guide rail and having opened both ends, the pipe being vertically movable along the fixing bolt.

According to another aspect of the present invention, there is provided a push-resistant device disposed on a lower end of a door and movable along a guide rail forming a sill, the push resistant device including: a pivot perpendicular to a moving direction of the door; and a plate member including a through hole through which the pivot passes and a portion inserted into a groove of the guide rail.

According to the present invention, an elevator door is prevented from being pushed toward a hoistway when a force is exerted on the elevator door in perpendicular direction to a moving direction of the elevator door, foreign objects accumulated in a groove of a guide rail are conveniently removed, and a locking device and a push-resistant device can be coupled to a door system.

Also, a plate hook of the push-resistant device is easily inserted into the locking device, so that reliability of operation is improved and noise of the operation is reduced.

### DRAWINGS

FIG. 1 is a perspective view illustrating a door system provided to a related art elevator door.

FIG. 2 is a cross-sectional view illustrating a push-resistant device and a locking device according to a first embodiment of the present invention.

FIG. 3 is a perspective view illustrating the push-resistant device and the locking device that have been mounted according to the first embodiment of the present invention.

FIG. 4 is a front view illustrating the push-resistant device according to the first embodiment of the present invention.

FIG. 5 is a perspective view illustrating a locking device according to a second embodiment of the present invention.

FIG. 6 is a cross-sectional view illustrating the locking device illustrated in FIG. 5, which is disposed on a guide rail.

FIG. 7 is a front view illustrating an elevator door coupled with a push-resistant device of the second embodiment, which is coupled to a locking device according to a third embodiment of the present invention.

FIG. 8 is a cross-sectional view illustrating a push-resistant device according to the third embodiment of the present invention.

FIG. 9 is a cross-sectional view illustrating a push-resistant device and a locking device that have been mounted according to a fourth embodiment of the present invention.

FIG. 10 is a perspective view illustrating the push-resistant device according to the fourth embodiment of the present invention.

FIG. 11 is a cross-sectional view illustrating a push-resistant device that has been mounted according to a fifth embodiment of the present invention.

FIG. 12 is a cross-sectional view illustrating a locking device of the fifth embodiment, which is coupled to a push-resistant device according to a sixth embodiment of the present invention.

FIG. 13 is a perspective view of the push-resistant device illustrated in FIG. 12.

FIG. 14 is a perspective view illustrating a locking device of the sixth embodiment, which is coupled to a push-resistant device according to a seventh embodiment of the present invention.

FIG. 15 is a cross-sectional view illustrating the locking device of the sixth embodiment and the push-resistant device, which have been mounted according to the seventh embodiment of the present invention.

FIG. 16 is a perspective view illustrating a push-resistant device according to an eighth embodiment of the present invention.

FIG. 17 is a perspective view illustrating a locking device of the seventh embodiment, which has been coupled to a push-resistant device according to a ninth embodiment of the present invention.

FIG. 18 is a perspective view illustrating the locking device of the seventh embodiment, which is coupled to the push-resistant device according to the ninth embodiment.

FIG. 19 is a perspective view illustrating a locking device according to the eighth embodiment of the present invention.

FIG. 20 is a cross-sectional view illustrating the locking device coupled to a guide rail according to the eighth embodiment of the present invention.

FIG. 21 is a cut-away perspective view illustrating a locking device according to the ninth embodiment of the present invention.

FIG. 22 is a cross-sectional view illustrating the locking device disposed on a guide rail according to the ninth embodiment of the present invention.

FIG. 23 is a cut-away perspective view illustrating a guide rail coupled with a locking device according to a tenth embodiment of the present invention.

FIG. 24 is a front perspective view illustrating the locking device illustrated in FIG. 23.

FIG. 25 is a rear perspective view illustrating the locking device illustrated in FIG. 23.

FIG. 26 is an exploded perspective view illustrating a process of coupling the locking device to the guide rail illustrated in FIG. 23.

FIG. 27 is a cross-sectional view illustrating the guide rail with the plate hook of the push-resistant device of the first embodiment removed according to the tenth embodiment of the present invention.

FIG. 28 is a cross-sectional view illustrating the guide rail with the plate hook of the push-resistant device of the first embodiment inserted according to the tenth embodiment of the present invention.

FIG. 29 is a perspective view illustrating a push-resistant device according to the tenth embodiment of the present invention.

FIG. 30 is a cross-sectional view taken along line B-B′ of FIG. 29.

FIG. 31 is a front view illustrating the push-resistant device according to the tenth embodiment of the present invention.

FIG. 32 is a cross-sectional view of the push-resistant device illustrated in FIG. 29, which has been disposed on a door.

FIG. 33 is a perspective view illustrating a push-resistant device according to an eleventh embodiment of the present invention.

FIG. 34 is a cross-sectional view taken along line B-B′ of FIG. 33.

FIG. 35 is a front view illustrating the push-resistant device according to the eleventh embodiment of the present invention.

FIG. 36 is a perspective view illustrating a push-resistant device according to a twelfth embodiment of the present invention.

FIG. 37 is a cross-sectional view taken along line B-B′ of FIG. 36.

FIG. 38 is a front view illustrating the push-resistant device according to the twelfth embodiment of the present invention.

FIG. 39 is a cross-sectional view illustrating the push-resistant device disposed on a door according to the twelfth embodiment of the present invention.

FIG. 40 is a perspective view illustrating a hook of the push-resistant device according to the twelfth embodiment of the present invention.

FIG. 41 is a perspective view illustrating a door system including a push-resistant device according to a thirteenth embodiment of the present invention.

FIG. 42 is a cross-sectional view taken along line A-A′ of FIG. 41.

FIG. 43 is a schematic view illustrating an operation of a hook illustrated in FIG. 41.

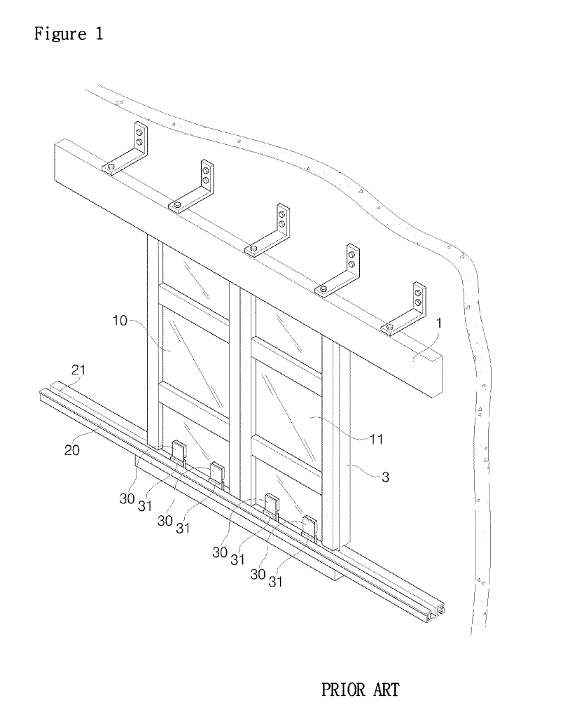

### DETAILED DESCRIPTION

The present invention will now be described more fully with reference to the accompanying drawings, in which exemplary embodiments of the invention are shown.

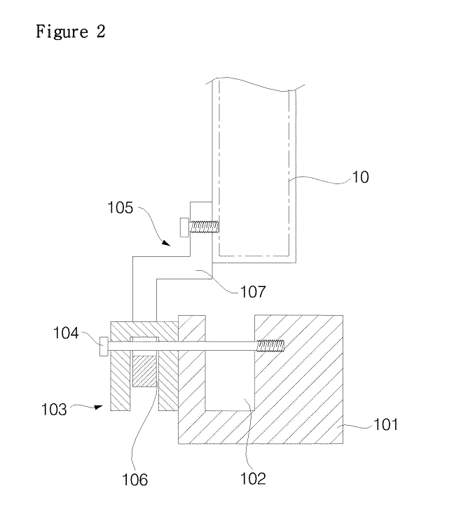

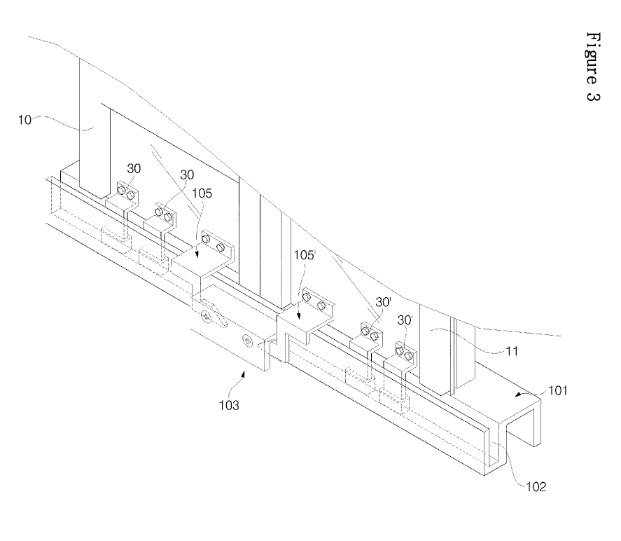

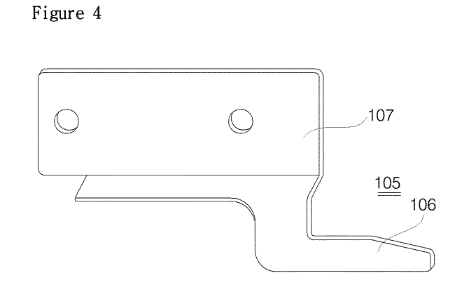

FIG. 2 is a cross-sectional view illustrating a push-resistant device and a locking device according to a first embodiment of the present invention, FIG. 3 is a perspective view illustrating the push-resistant device and the locking device that have been mounted according to the first embodiment of the present invention, and FIG. 4 is a front view illustrating the push-resistant device according to the first embodiment of the present invention.

A door 10 is provided to an elevator or a platform including a subway platform. The door 10 is closed or opened for an entrance, in which the door 10 may be provided in duplicate.

A guide rail 101 is placed vertically below the door 10. The guide rail 101 includes a groove 102 and forms a sill disposed in a moving direction of the door 10. Guide shoes 30 are disposed at a lower side of the door 10 and inserted into the groove 102 to be movable in a longitudinal direction of the guide rail 101.

A locking device 103 is disposed on an outer side of the guide rail 101. The outer side is defined as a distant side from the entrance. The locking device 103 has an upper surface, side surfaces bending from both sides of the upper surface and extended downward, and an open lower portion to form an approximately reversed U-shape. The open lower portion adjacent to ends of the side surfaces, allows a plate hook 106 of a push-resistant device 105 to be inserted into the locking device 103. The locking device 103 is coupled to the outer side of the guide rail 101 with a bolt 104 or a welding process, as illustrated in FIG. 2.

The push-resistant device 105 is disposed on a side portion of a lower end of the door 10. An upper portion of the push-resistant device 105 is attached to the side portion of the lower end of the door 10, and a lower portion of the push-resistant device 105 protrudes below a lower portion of the door 10. The push-resistant device 105 includes a bracket 107 and the plate hook 106. The bracket 107 includes an upper portion, a bent portion, and a lower portion. The upper portion of the bracket 107 is connected to the lower portion of the bracket 107 through the bent portion of the bracket 107. The plate hook 106 from the bracket 107 protrudes in a closing direction of the door 10. When the door 10 is closed, the plate hook 106 is inserted into a space defined by the upper surface and the side surfaces of the locking device 103, so that the plate hook 106 is locked to prevent the door 10 from being pushed perpendicular to the moving direction of the door 10.

In the case where the door 10, which is closed or opened for the entrance, is provided in duplicate, the locking device 103 is disposed in the middle of the guide rail 101 to allow the push-resistant devices 105 of doors 10 to be inserted and locked into both sides of the locking device 103, respectively. Thus, the locking device 103 does not have to be provided in duplicate to achieve a simple construction. In the case where the single door 10 is closed or opened for the entrance, the locking device 103 is disposed at a position allowing the plate hook 106 of the push-resistant device 105 to be inserted into the locking device 103 when the entrance is closed.

In the case where the door 10, which may be provided at various places, is provided at the entrance of the elevator, since the door 10 is spaced 30 mm from a cage door, the locking device 103 protrudes 20 mm or less from the outer side of the guide rail 101. That is, the locking device 103 has a width of 20 mm or less.

Referring to FIG. 3, the doors 10 and 11 are closed or opened for the entrance. The locking device 103 is disposed at the center of the outer side of the guide rail 101. The movable guide shoes 30 along the groove 102 of the guide rail 101 are disposed on the lower side of the door 10, and movable guide shoes 30′ along the groove 102 of the guide rail 101 are disposed at a lower side of a door 11. Also, the push-resistant device 105, which is also illustrated in FIG. 4, is disposed to the lower side portion of the door 10, and a push-resistant device 105′, having the same shape as that of the push-resistant device 105, is disposed on the lower side portion of the door 11. The push-resistant devices 105 and 105′ are disposed closer to the longitudinal center of the guide rail 101 than the guide shoes 30 and 30′, and are locked into the locking device 103 when the doors 10 and 21 are closed.

The plate hook 106 disposed in the lower portion of the bracket 107 of the push-resistant device 105, protrudes in the closing direction of the door 10, that is, toward the longitudinal center of the guide rail 101. An upper surface of the plate hook 106 is inclined downward toward its front end such that the plate hook 106 is easily inserted into the locking device 103. The upper surface of the plate hook 106 may be coated to prevent noise caused by the insertion of the plate hook 106. Specifically, the plate hook 106 is inserted into the space defined by the upper surface and the side surfaces of the locking device 103 when the doors 10 and 11 are closed. When the doors 10 and 11 are opened, the plate hook 106 is removed from the space. Likewise, a plate hook of the push-resistant device 105′ disposed on the door 11, protrudes toward the longitudinal center of the guide rail 101 and is inserted into the space at the opposite side of the plate hook 106 when the doors 10 and 11 are closed.

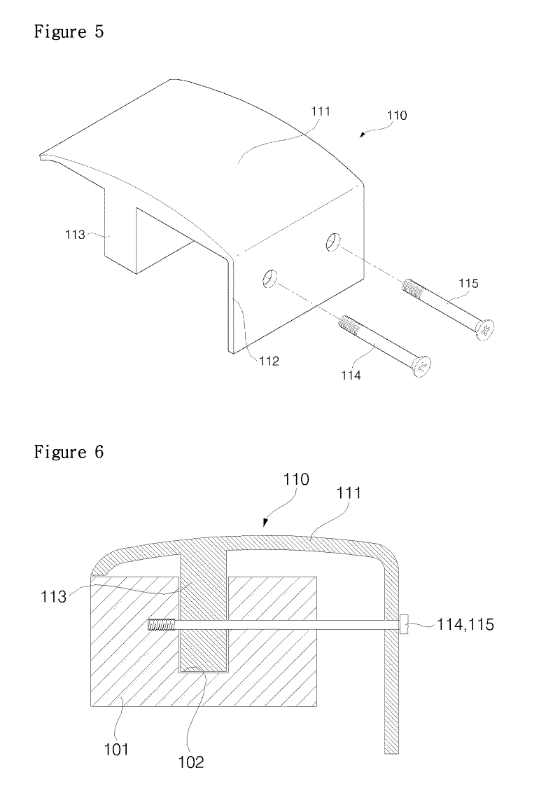

FIG. 5 is a perspective view illustrating a locking device according to a second embodiment of the present invention, and FIG. 6 is a cross-sectional view illustrating the locking device illustrated in FIG. 5, which is disposed on a guide rail.

Referring to FIG. 5, a locking device 110 includes an upper plate 111, a vertical plate 112 bent downward from a side portion of the upper plate 111, and a groove insertion portion 113 protruding downward from a bottom of the upper plate 111 for being inserted into a groove 102 of a guide rail 101. The locking device 110 is coupled using bolts 114 and 115.

In the case where the two doors 10 and 11 are opened or closed for the entrance as illustrated in FIG. 2, the locking device 110 is disposed at a longitudinal center of the guide rail 101. The groove insertion portion 113 of the locking device 110 is inserted into the groove 102 and then coupled to the groove 102 with the bolts 114 and 115 that have threads on their end portions, respectively.

The locking device 110 is disposed on the guide rail 101 with the vertical plate 112 being spaced apart from an outer side of the guide rail 101, and the push-resistant devices 105 of the first embodiment illustrated in FIG. 4 are disposed on the doors 10 and 11. Accordingly, when the doors 10 and 11 are closed, the plate hook 106 is inserted and locked into a space that is defined by the upper plate 111, the vertical plate 112, and the outer side of the guide rail 101.

The space receiving the plate hook 106 of the push-resistant device 105 may be defined by the outer side of the guide rail 101 and a different locking device other than the locking devices illustrated in FIGS. 2 through 6.

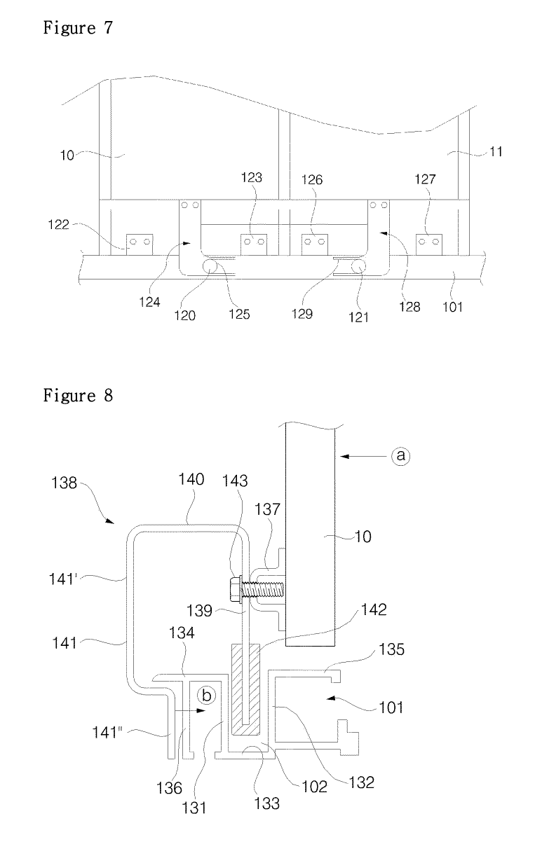

FIG. 7 is a front view illustrating an elevator door coupled with a push-resistant device of the second embodiment, which is coupled to a locking device according to a third embodiment of the present invention.

Referring to FIG. 7, locking devices 120 and 121 are protruding parts that protrude in perpendicular to a longitudinal direction of a guide rail 101 and are disposed on an outer side of the guide rail 101. Each of the locking devices 120 and 121 may have a bolt or screw shape. A portion of each of the locking devices 120 and 121 threads into the guide rail 101, and another portion includes a head protruding from the outer side of the guide rail 101.

Guide shoes 122 and 123 are disposed on lower both sides of a door 10, and a push-resistant device 124 is disposed in a middle portion between the guide shoes 122 and 123. An upper portion of the push-resistant device 124 is attached to a lower side of the door 10 using a screw. An insertion portion 125 formed in a horizontal direction, is disposed in a lower portion of the push-resistant device 124 such that the locking device 120 is inserted into the insertion portion when the door 10 is closed. That is, the insertion portion 125 is opened toward a longitudinal center of the guide rail 101. When the door 10 is moved to its closed position, the locking device 120 of the push-resistant device 124 is inserted into the insertion portion 125. When the push-resistant device 124 coupled with the locking device 120 is pushed perpendicular to a moving direction of the door 10, a torque is exerted on the insertion portion 125. However, the insertion portion 125 is coupled to the locking device 120 to prevent the door 10 from being pushed perpendicular to the moving direction of the door 10. Likewise, guide shoes 126 and 127 and a push-resistant device 124 that have the same configuration as those of the door 10, are provided to a door 11. An insertion portion 129, which is opened in a closing direction of the door 11, is disposed in a lower portion of a push-resistant device 128. When the door 11 is closed, the locking device 121 protruding from the outer side of the guide rail 101, is inserted and locked into the insertion portion 129.

FIG. 8 is a cross-sectional view illustrating a push-resistant device according to the third embodiment of the present invention.

A guide rail 101 forming a door sill includes a groove 102 that is opened upward. The groove 102 is formed in a longitudinal direction of the guide rail 101. The groove 102 is defined by both side surfaces 131 and 132 and a bottom surface 133. Upper surfaces 134 and 135 are perpendicularly bent outward from upper ends of the side surfaces 131 and 132, respectively. The term outward is defined as away from a door 10. An outer wall 136, which is parallel to the side surface 131, protrudes downward from a lower side spaced inward from an end of the upper surface 134.

A reinforced support 137 disposed on a lower portion of the door 10 includes an upper portion and a lower portion that are coupled to the door 10, and a middle portion that is convex outward and spaced apart from the door 10. A push-resistant device 138 is disposed on the reinforced support 137.

The push-resistant device 138 includes a coupling portion 139 coupled to the reinforced support 137, a connecting portion 140 bent outward from an upper end of the coupling portion 139, and a supporting portion 141 bent downward from an outer end of the connecting portion 140

A lower end of the coupling portion 139 is inserted into the groove 102. A synthetic resin packet 142 having a predetermined thickness is disposed on an outer surface of the lower end. When the door 10 is moved, the packet 142 is also moved along the groove 102. Thus, the push-resistant device 138 also serves as a typical guide shoe when the door 10 is moved.

An upper portion 141′ of the supporting portion 141 is bent downward from the outer end of the connecting portion 140. The supporting portion 141 is bent from the upper portion 141′ toward the outer wall 136 and bent again downward to form a lower portion 141″.

When a perpendicular force to the door 10, that is, an arrow \textcircled{a} indicating direction force is exerted on the door 10, an arrow \textcircled{b} indicating direction force is exerted on the lower portion 141″ of the upper portion 141′. Thus, the lower portion 141″ is supported by the outer wall 136 to prevent the door 10 from being pushed perpendicular to a moving direction of the door 10.

The supporting portion 141 of the door 10 is coated with a synthetic resin to prevent noise caused by the supporting portion 141 in contact with the guide rail 101.

The push-resistant device 138 may be provided without the packet 142. Instead, a separate guide shoe is provided on a lower portion of the door 10. The push-resistant device 138 is coupled to the reinforced support 137 with a screw 143 or a welding process.

Although the connecting portion 140 having a horizontal surface is provided, a connecting portion having an upward convex surface may be provided to improve bending strength.

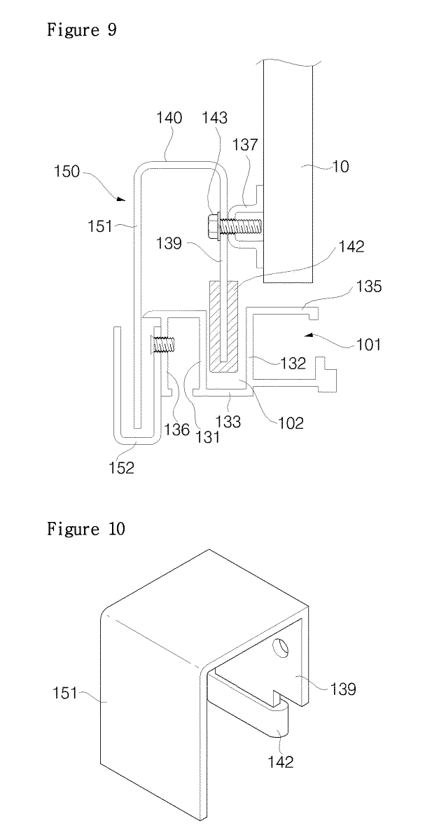

FIG. 9 is a cross-sectional view illustrating a push-resistant device and a locking device that have been mounted according to a fourth embodiment of the present invention, and FIG. 10 is a perspective view illustrating the push-resistant device according to the fourth embodiment of the present invention.

Referring to FIG. 9, a push-resistant device 150 is identical to the push-resistant device 138 of the third embodiment except for a supporting portion 151. Accordingly, like reference numerals denote like elements and its description will be omitted.

The supporting portion 151 is bent downward from an end of a connecting portion 140. A guide rail 101 includes an outer wall 136 on which the supporting portion 151 is disposed when a door 10 is closed. An approximately U-shaped locking device 152 is disposed on the outer wall 136.

The supporting portion 151 is inserted into the locking device 152 when the door 10 is closed. When a perpendicular force is exerted on the door 10, the supporting portion 151 is in contact with a wall of the locking device 152 to prevent the door 10 from being pushed perpendicular to a moving direction of the door 10.

A packet 142 serves as a guide shoe, which is disposed on a lower end of a coupling portion 139 of the push-resistant device 150. A separate guide shoe may be provided to the door 10 without the packet 142.

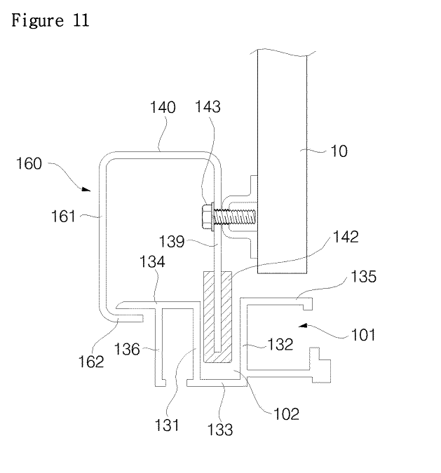

FIG. 11 is a cross-sectional view illustrating a push-resistant device that has been mounted according to a fifth embodiment of the present invention.

Referring to FIG. 11, a push-resistant device 160 is identical to the push-resistant device 150 of the fourth embodiment except for a supporting portion.

The supporting portion of the push-resistant device 160 includes an upper portion 161 bent downward from an end of a connecting portion 140, and a bent portion 162 bent inward from a lower end of the upper portion 161 toward an outer wall 136 of a guide rail 101.

When a perpendicular force is exerted on a door 10 coupled with the push-resistant device 160, an end of the bent portion 162 is in contact with the outer wall 136 of the guide rail 101 or a bottom surface opposite to an upper surface 134 to prevent the door 10 from being pushed perpendicular to a moving direction of the door 10.

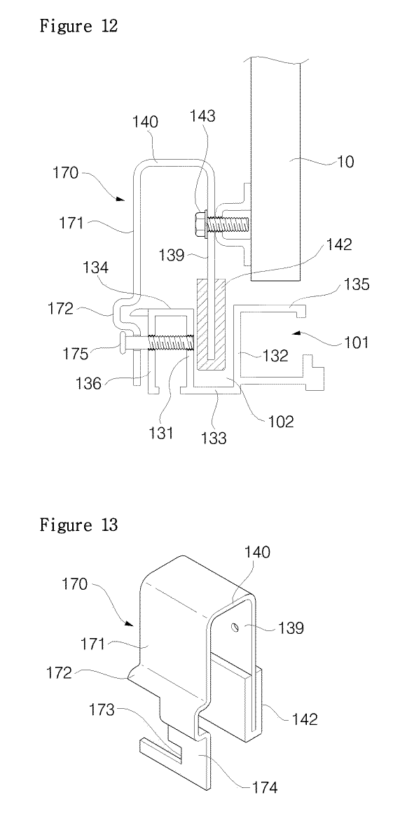

FIG. 12 is a cross-sectional view illustrating a locking device of the fifth embodiment, which is coupled to a push-resistant device according to a sixth embodiment of the present invention, and FIG. 13 is a perspective view of the push-resistant device illustrated in FIG. 12.

Referring to FIG. 12, a push-resistant device 170 is identical to the push-resistant device 138 of the third embodiment for a supporting portion. The supporting portion of the push-resistant device 170 includes an upper portion 171 bent downward from a connecting portion 140, a convex portion 172 bent and extended downward from the upper portion 171, and an insertion portion 174 bent and extended downward from the convex portion 172 and having an insertion opening 173. The convex portion 172 includes a middle portion having an outward convex surface. An outer end of an upper surface 134 of a guide rail 101 is inserted into the middle portion having the outward convex surface. The insertion opening 173 is disposed in a closing direction of a door 10.

A bolt 175 serves as a locking device in the fifth embodiment, which is located within the insertion opening 173 of the push-resistant device 170 when a door 10 is closed. The bolt 175 protrudes outward from an outer wall 136 of the guide rail 101 such that a protruding portion of the bolt 175 is inserted into the insertion opening 173 of the push-resistant device 170 when the door 10 is closed.

A direction of the insertion opening 173 is determined such that the protruding portion of the bolt 175 is inserted into the insertion opening 173 when the door 10 is closed, and the protruding portion of the bolt 175 is removed from the insertion opening 173 when the door 10 is opened. Thus, in the case where the door 10 is closed and the bolt 175 of the guide rail 101 is inserted into the insertion notch 173, when a perpendicular force is exerted on the door 10, the push-resistant device 170 prevents the door 10 from being moved vertically and being pushed perpendicular to a moving direction of the door 10.

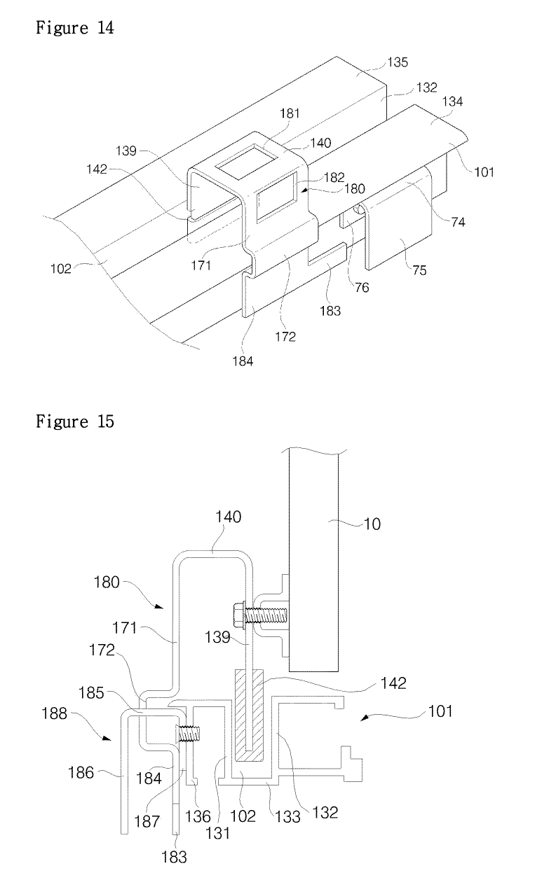

FIG. 14 is a perspective view illustrating a locking device of the sixth embodiment, which is coupled to a push-resistant device according to a seventh embodiment of the present invention, and FIG. 15 is a cross-sectional view illustrating the locking device of the sixth embodiment and the push-resistant device, which have been mounted according to the seventh embodiment of the present invention.

A push-resistant device 180 is identical to the push-resistant device 138 of the third embodiment except for a supporting portion and a connecting portion 140 having a through hole 181. The supporting portion is bent downward from the connecting portion 140. The supporting portion includes an upper portion 171 bent downward from the connecting portion 140 and including a through hole 182, a convex portion 172 bent and extended downward from the upper portion 171, and an insertion portion 174 bent and extended downward from the convex portion 172 and having a plate hook 183. The convex portion 172 includes a middle portion having an outward convex surface. An outer end of an upper surface 134 of a guide rail 101 is inserted into the middle portion having the outward convex surface. The plate hook 183 is formed in a closing direction of a door 10. The through holes 181 and 182 respectively of the upper portion 140 and the connecting portion 171 are adapted to prevent foreign objects being accumulated in a groove 102 and conveniently remove foreign objects from the groove 102.

A locking device 188 of the sixth embodiment is disposed on an outer wall 136 of the guide rail 101. The locking device 188 includes an upper surface 185 and side surfaces 186 and 187. The side surfaces 186 and 187 are bent downward from both sides of the upper surface 185. The side surface 187 is coupled to the outer wall 136 using a screw.

The locking device 188 is disposed to allow the plate hook 183 of the push-resistant device 180 to be inserted into a space defined by the upper surface 185 and the side surfaces 186 and 187 when the door 10 is closed. Thus, in the case where the door 10 is closed, when a perpendicular force is exerted on the door 10, the plate hook 183 is locked into the locking device 188 to prevent the door 10 from being pushed perpendicular to a moving direction of the door 10.

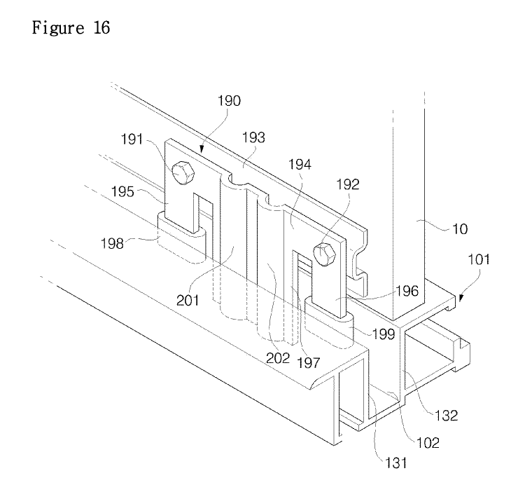

FIG. 16 is a perspective view illustrating a push-resistant device according to an eighth embodiment of the present invention.

A push-resistant device 190 includes flat coupling portion 194, flat packet-coupling portions 195 and 196, a push-resistant portion 197, packets 198 and 199 serving as a guide shoe. The coupling portion 194 is coupled to a reinforced support 193 with screws 191 and 192. The flat packet-coupling portions 195 and 196 are extended from lower ends of the coupling portion 194, respectively. The push-resistant portion 197 is extended from a middle lower end of the coupling portion 194. The packets 198 and 199 are coupled to ends of the packet-coupling portions 195 and 196, respectively. Outward convex surfaces 201 and 202 are formed on the coupling portion 194 and the push-resistant portion 197 extended from the coupling portion 194, to improve bending strength of the push-resistant portion 1 97 and the coupling portion 194.

Since a distance from an upper end of the coupling portion 194 to a lower end of the push-resistant portion 197 is greater than a distance from the upper end of the coupling portion 194 to a lower end of each of the packets 198 and 199, when the push-resistant device 190 is provided to a door 10, the lower end of the push-resistant portion 197 is more deeply inserted into a groove 102 of a guide rail 101 than the lower ends of the packets 198 and 199.

As such, when the push-resistant portion 197 is deeply inserted into the groove 102 and a perpendicular force is exerted on the door 10, the push-resistant portion 197 is supported by side surfaces 131 and 132 of the groove 102 to prevent the door 10 from being pushed away.

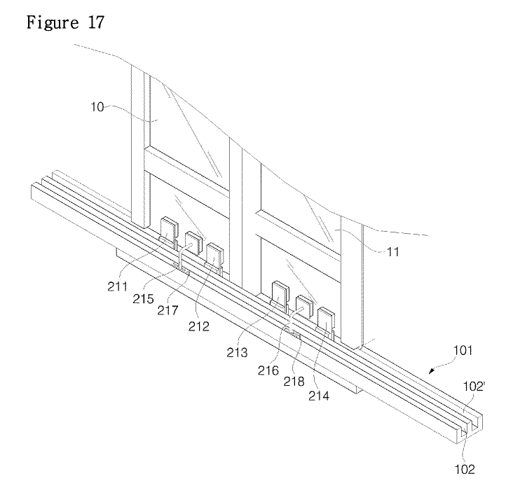

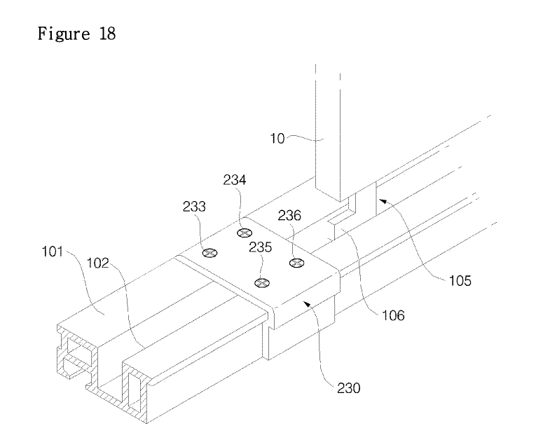

FIG. 17 is a perspective view illustrating a locking device of the seventh embodiment, which has been coupled to a push-resistant device according to a ninth embodiment of the present invention, and FIG. 18 is a perspective view illustrating the locking device of the seventh embodiment, which is coupled to the push-resistant device according to the ninth embodiment of the present invention.

A guide rail 101 forming a guide sill is disposed on lower portions of doors 10 and 11. Each of two grooves 102 and 102′ is formed in the guide rail 101 in a longitudinal direction of the guide rail 101. Guide shoes 211, 212, 213, and 214 are disposed on the lower portions of doors 10 and 11 and are movable along the groove 102′ adjacent to a floor.

Push-resistant devices 215 and 216 of the ninth embodiment are disposed on lower middle portions of the doors 10 and 11, respectively. When the doors 10 and 11 are closed, the push-resistant devices 215 and 216 are inserted into locking devices 217 and 218 of the seventh embodiment, respectively. The locking devices 217 and 218 are disposed in the groove 102 adjacent to a hoistway for an elevator cage.

Referring to FIG. 18, the push-resistant device 215 of the ninth embodiment includes a fixing plate 219, a protruding bar 220, and a circular flange 221. The fixing plate 219 is used to couple the push-resistant device 215 to the lower portion of the door 10. The protruding bar 220 includes a horizontal portion protruding from the fixing plate 219 and a vertical portion bent from the horizontal portion. The circular flange 221 is disposed on an end of the vertical portion of the protruding bar 220. The locking device 217 includes a mounting plate 222, and a housing 224. The mounting plate 222 is disposed on a bottom of the groove 102. The vertical portion of the protruding bar 220 of the push-resistant devices 215 is inserted a predetermined length into the opening in a moving direction of the door 10 when the door 10 is closed. An upper plate 223 is disposed in an upper portion of the mounting plate 222. When the vertical portion 16 is inserted into the opening, the circular flange 221 is inserted and locked into the housing 224.

As such, a position of the locking device 217 in the groove 102 makes it possible that the vertical portion of the push-resistant devices 215 is inserted into the opening of the locking device 217 and the circular flange 221 is disposed in the housing when the door 10 is closed.

Although the locking devices 217 and 218 are disposed in the groove 102, and the guide shoes 211, 212, 213, and 214 are movable along the groove 102′ in FIGS. 17 and 18, the locking devices 217 and 218 receiving the push-resistant devices 215 and 216 may be disposed in the groove 102′ adjacent to the floor.

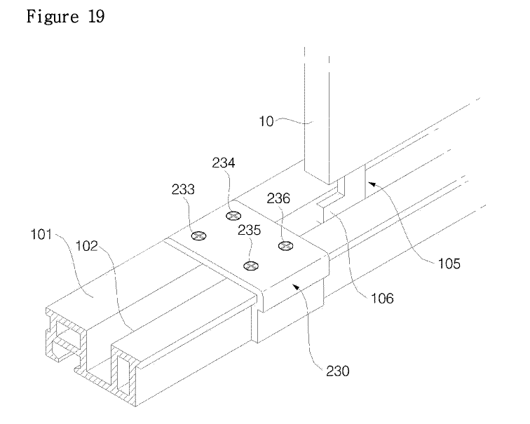

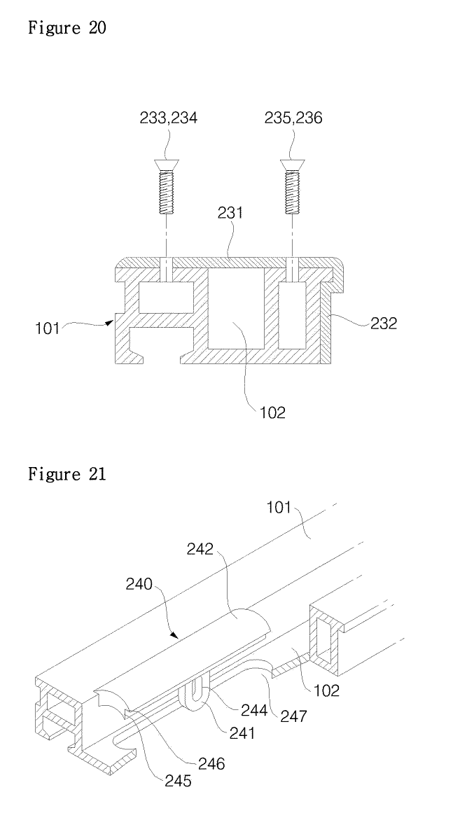

FIG. 19 is a perspective view illustrating a locking device according to the eighth embodiment of the present invention, and FIG. 20 is a cross-sectional view illustrating the locking device coupled to a guide rail according to the eighth embodiment of the present invention.

A guide rail 101 forming a door sill is disposed on a lower portion of a door 10 that is closed or opened for entrances of an elevator cage and a floor. The push-resistant device 105 of the first embodiment is disposed on a lower end of the door 10. The plate hook 106 of the push-resistant device 105 protrudes in a moving direction of the door 10. When the door 10 is closed, the plate hook 106 of the push-resistant device 105 is moved along a door movement path and inserted into a space defined by a groove 102 and a locking device 230 disposed on the guide rail 101, to prevent the door 10 from being pushed perpendicular to the moving direction of the door 10.

In the case where the door 10 is provided in duplicate, and the doors 10 are moved toward each other to be closed, the locking device 230 is disposed in the middle of the guide rail 101. In the case where a single door is closed or opened for the entrance, the locking device 230 is disposed on one side of the guide rail 101.

The guide rail 101 includes the groove 102 into which a movable guide shoe of the door 10 is inserted. The locking device 230 includes a horizontal portion 231 covering an opening of the groove 102 and a side portion 232 bent downward from the horizontal portion 231 for being in contact with an outer side the guide rail 101.

Since the horizontal portion 231 of the locking device 230 is attached to an upper surface of the guide rail 101 with screws 233, 234, 235, and 236, the locking device 230 is vertically coupled to the guide rail 101 with the screws 233, 234, 235, and 236 to provide convenient assembly.

A longitudinal through hole is disposed in a portion facing the horizontal portion 231 in a bottom of the groove 102 such that foreign objects are removed from the groove 102 through the through hole.

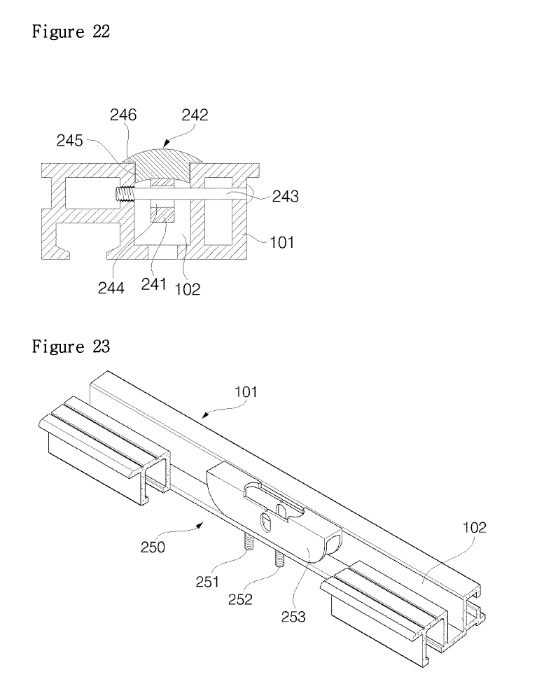

FIG. 21 is a cut-away perspective view illustrating a locking device according to the ninth embodiment of the present invention, and FIG. 22 is a cross-sectional view illustrating the locking device disposed on a guide rail according to the ninth embodiment of the present invention.

A locking device 240 of the ninth embodiment includes a moving stem 241 movable in vertical to a bottom of a groove 102 in a guide rail 101, and a cover 242 for covering the groove 102. The moving stem 241 is disposed in the middle of the cover 242. The moving stem 241 includes a slot 244 through which a coupling bolt 243 passes perpendicular to a longitudinal direction of the groove 102.

Since the slot 244 has a vertical length greater than a horizontal width, the locking device 240 is vertically movable with respect to the coupling bolt 243.

The cover 242 includes an insertion portion 245 and a flange portion 246. The insertion portion 245 has a width less than that of the groove 102 to be inserted into the groove 102. The flange portion 246 has a width greater than that of the insertion portion 245, to be hung up on an upper surface of the guide rail 101.

The bottom of the groove 102, which faces the locking device 240, includes a through hole 247 such that foreign objects are removed from the groove 102 through the through hole 247. The through hole 247 is disposed in the longitudinal direction of the groove 102.

Referring back to FIG. 4, the push-resistant device 105 of the first embodiment is disposed on the doors 10 and 11. When the doors 10 and 11 are closed, the plate hook 106 of the push-resistant device 105 disposed on each of the doors 10 and 11 is inserted into a space defined by the groove 102 and both ends of the cover 242 of the locking device 240. In the case where the plate hooks 106 are asynchronously inserted into the space, although a torque is exerted on the insertion portion 245 about the moving stem 241, the flange portion 246 of the cover 242 prevents the cover 242 from being rotated by the torque. Also, the moving stem 241 is raised such that the inclined front end of the plate hook 106 is inserted into the space and then the cover 242 is gradually raised along the inclined surface of the plate hook 106. Thus, the plate hook 106 is easily inserted into the space.

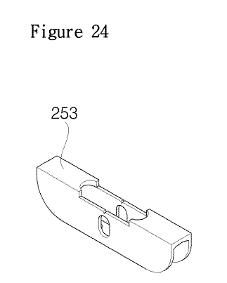

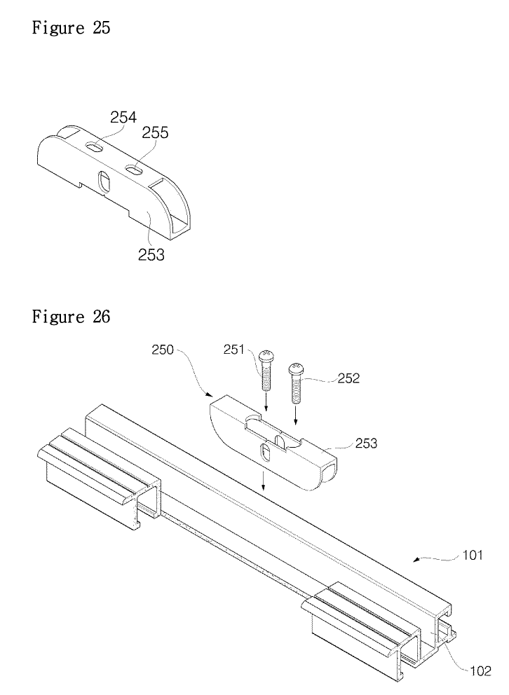

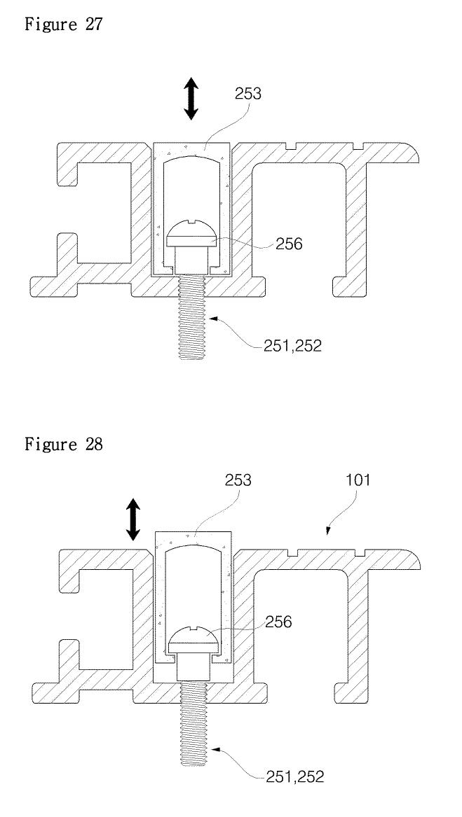

FIG. 23 is a cut-away perspective view illustrating a guide rail coupled with a locking device according to a tenth embodiment of the present invention, FIG. 24 is a front perspective view illustrating the locking device illustrated in FIG. 23, FIG. 25 is a rear perspective view illustrating the locking device illustrated in FIG. 23, FIG. 26 is an exploded perspective view illustrating a process of coupling the locking device to the guide rail illustrated in FIG. 23, FIG. 27 is a cross-sectional view illustrating the guide rail with the plate hook of the push-resistant device of the first embodiment removed according to the tenth embodiment of the present invention, and FIG. 28 is a cross-sectional view illustrating the guide rail with the plate hook of the push-resistant device of the first embodiment inserted according to the tenth embodiment of the present invention.

The plate hook 106 of the push-resistant device 105 of the first embodiment as illustrated in FIG. 4 is inserted into a locking device 250 of the tenth embodiment when the doors 10 and 11 are closed. The locking device 250 is disposed in a groove 102 of a guide rail 101.

The locking device 250 includes a pipe 253. The pipe 253 is coupled to the groove 102 of the guide rail 101 using fixing bolts 251 and 252, to be vertically movable.

An upper surface of the pipe 253 is longer than a lower surface of the pipe 253, and connecting portions between ends of the upper and lower surfaces are rounded. Thus, the plate hook 106 of the push-resistant device 105 is easily inserted into the pipe 253. When the plate hook 106 is removed from the pipe 253, the lower surface of the pipe 253 is in contact with a bottom of the groove 102 of the guide rail 101. When the plate hook 106 is inserted into the pipe 253, the pipe 253 is vertically raised by the plate hook 106. An opening formed in the middle of the upper surface of the pipe 253 in a longitudinal direction of the pipe 253. Slots 254 and 255 are formed in the lower surface of the pipe 253. Each of the slots 254 and 255 has a long axis in the longitudinal direction of the pipe 253. The fixing bolts 251 and 252 are attached to the bottom of the groove 102 through the slots 254 and 255. In here, a head 256 of each of the fixing bolts 251 and 252 protrudes upward and is spaced apart from the lower surface of the pipe 253. Thus, when the plate hook 106 is inserted into the pipe 253, the pipe 253 is vertically movable along the fixing bolts 251 and 252, and a movement distance of the pipe 253 is limited by the head 256, as illustrated in FIG. 28.

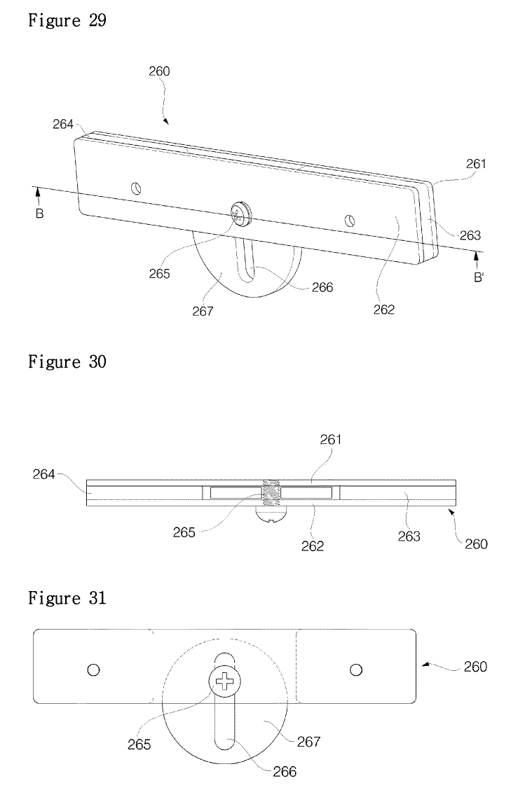

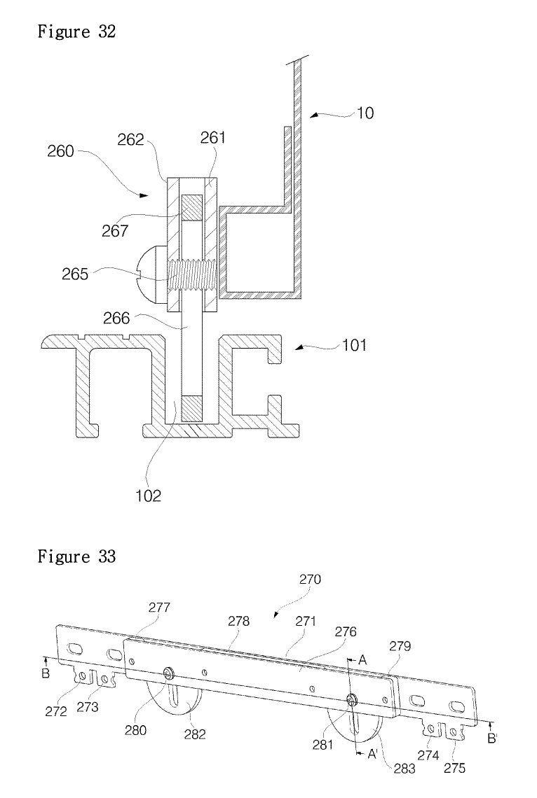

FIG. 29 is a perspective view illustrating a push-resistant device according to the tenth embodiment of the present invention, FIG. 30 is a cross-sectional view taken along line B-B′ of FIG. 29, FIG. 31 is a front view illustrating the push-resistant device according to the tenth embodiment of the present invention, and FIG. 32 is a cross-sectional view of the push-resistant device illustrated in FIG. 29, which has been disposed on a door.

A push-resistant device 260 of the tenth embodiment is disposed on the lower side of the door 10.

The push-resistant device 260 includes two supporting plate 261 and 262, insertion plates 263 and 264, a pivot 265, and a push-resistant plate 267 having a slot 266 through which the pivot 265 passes. The supporting plate 261 and 262 are parallel with each other. The insertion plates 263 and 264 are disposed at both longitudinal ends of the supporting plate 261 and 262 between the supporting plates 261 and 262. The pivot 265 passes through the supporting plate 261 and 262 and a space defined by the insertion plates 263 and 264 and the supporting plate 261 and 262. The push-resistant plate 267 having a circular plate shape or an oval plate shape, is vertically movable and rotatable about the pivot 265. The slot 266 is disposed at a center of the push-resistant plate 267.

The supporting plate 261 of the push-resistant device 260 is disposed on the lower side of the door 10 with a screw or a welding process. As illustrated in FIG. 32, a mounting height of the push-resistant device 260 is determined such that when the door 10 is closed, an outer circumference of the push-resistant device 260 is in contact with a bottom of a groove 102 at a point where the outer circumference intersects a line extended from a long axis of the slot 266 in the push-resistant plate 267, and the pivot 265 is located higher than a center of the long axis of the slot 266.

Thus, when a force perpendicular to a moving direction of the door 10 is exerted on the door 10, the push-resistant plate 267 is in contact with a side wall defining the groove 102 to prevent the door 10 from being pushed away from its normal position.

Also, when the door 10 is moved and the outer circumference of the push-resistant plate 267 is in contact with foreign objects accumulated in the groove 102, the push-resistant plate 267 is vertically raised or rotated about the pivot 265. Thus, the door 10 is smoothly moved without friction.

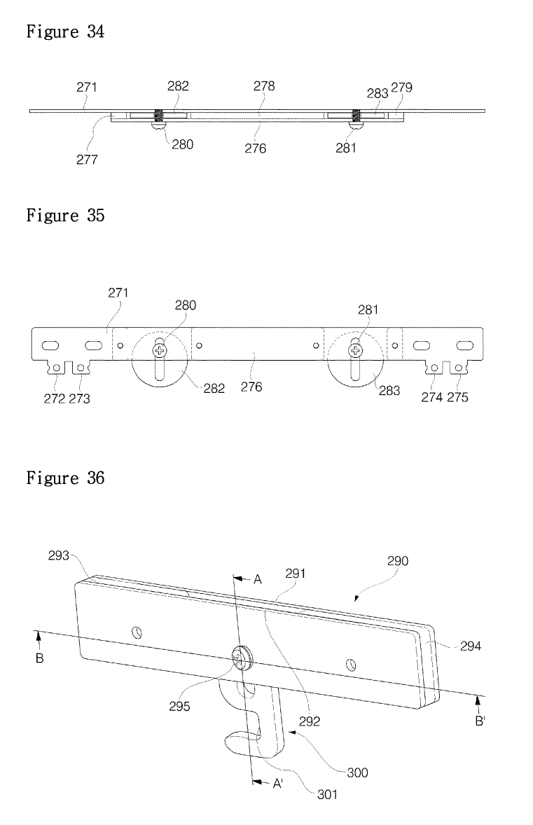

FIG. 33 is a perspective view illustrating a push-resistant device according to an eleventh embodiment of the present invention, FIG. 34 is a cross-sectional view taken along line B-B′ of FIG. 33, and FIG. 35 is a front view illustrating the push-resistant device according to the eleventh embodiment of the present invention.

A push-resistant device 270 of the eleventh embodiment includes supporting plates 271 and 276, insertion plates 277, 278, and 279, pivots 280 and 281, and push-resistant plates 282 and 283 respectively having slots. Guide shoes-coupling plates 272, 273, 274, and 275 protrude from lower portions of both ends of the supporting plate 271. The supporting plate 271 is attached to the lower side of the door 10. The supporting plate 276 is shorter than, parallel with, and spaced a predetermined distance from the supporting plate 271. The insertion plates 277, 278, and 279 are spaced apart from each other between the supporting plates 271 and 276. The pivots 280 and 281 pass through a space defined by the insertion plates 277, 278, and 279 and the supporting plates 271 and 276. Also, the pivots 280 and 281 pass through the slots, respectively. The push-resistant plates 282 and 283 are vertically movable and rotatable about the pivots 280 and 281. A portion of each of the push-resistant plates 282 and 283 is inserted between the supporting plates 271 and 276. Another portion of each of the push-resistant plates 282 and 283 protrudes downward from lower ends of the supporting plates 271 and 276 and is inserted into the groove 102 of the guide rail 101.

Packets (not shown) of guide shoes are formed of a synthetic resin and disposed on the packet-coupling plates 272, 273, 274, and 275.

A longitudinal center of the supporting plate 271 longer than the supporting plate 276 may be coincided with a longitudinal center of the supporting plate 276.

The push-resistant plates 282 and 283 disposed between the supporting plates 271 and 276 are identical to the push-resistant plate 267 of the tenth embodiment in configuration.

As such, the two push-resistant plates 282 and 283 vertically movable and rotatable about the pivots 280 and 281 are provided between the supporting plates 271 and 276, thereby improving push-resistant performance in comparison with the tenth embodiment. Also, the guide shoes are integrally formed with the lower portions of the both ends of the supporting plate 271, thereby reducing the number of processes.

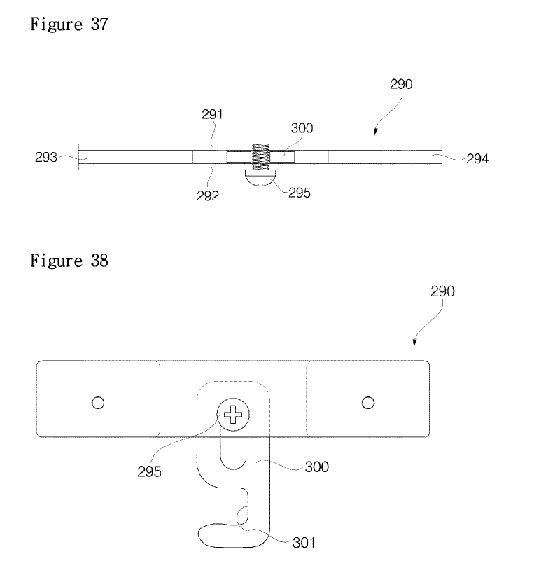

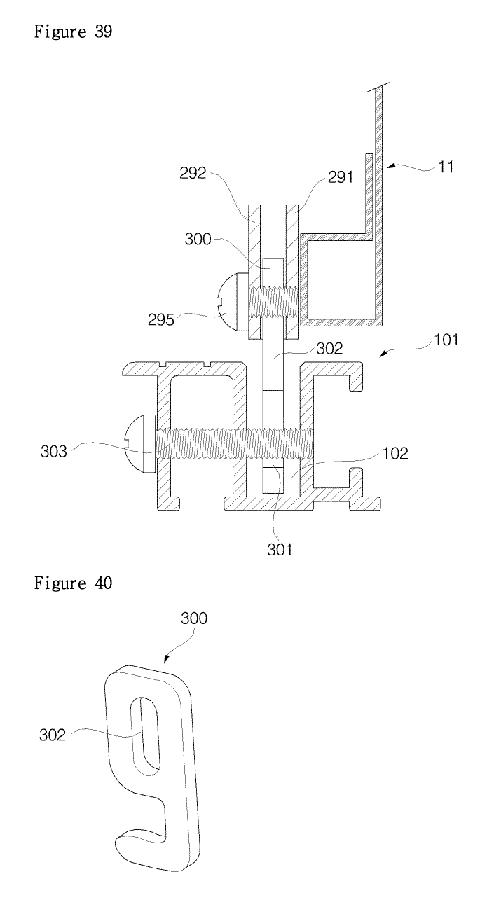

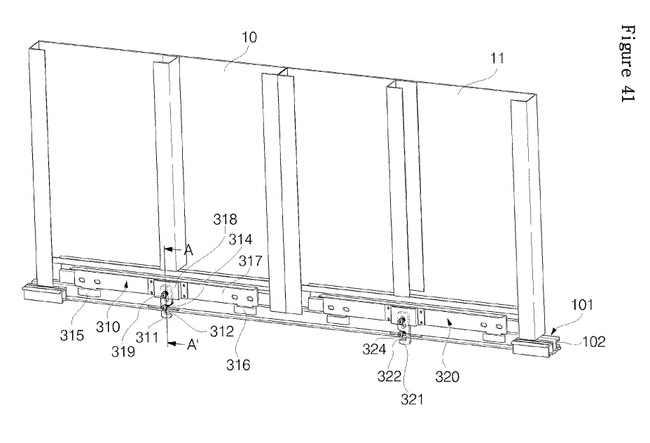

FIG. 36 is a perspective view illustrating a push-resistant device according to a twelfth embodiment of the present invention, FIG. 37 is a cross-sectional view taken along line B-B′ of FIG. 36, FIG. 38 is a front view illustrating the push-resistant device according to the twelfth embodiment of the present invention, FIG. 39 is a cross-sectional view illustrating the push-resistant device disposed on a door according to the twelfth embodiment of the present invention, and FIG. 40 is a perspective view illustrating a hook of the push-resistant device according to the twelfth embodiment of the present invention.

A push-resistant device 290 of the twelfth embodiment is disposed on a lower side of a door 11. When the door 11 is closed, a bolt 295 across a groove 102 of a guide rail 101 is inserted into a hook opening 300 of a hook 300 in the push-resistant device 290 to prevent the door 11 from being pushed perpendicular to a moving direction of the door 11.

The push-resistant device 290 includes two insertion plates 293 and 294, a pivot 295, and a hook 300 having a slot 302 with a vertical long axis. The insertion plates 293 and 294 are inserted between two supporting plates 291 and 292 disposed on the lower side of the door 11 such that the supporting plates 291 and 292 are spaced apart from each other. The pivot 295 includes a bolt passing through a space defined by the insertion plates 293 and 294 and the supporting plates 291 and 292. The pivot 295 also passes through the slot 302. The hook opening 301 having an approximately “C” shape is disposed in a closing direction of the door 11 and disposed in a lower portion of the hook 300.

The bolt 303 is disposed in the groove 102 of the guide rail 101, to be inserted into the hook opening 301 of the hook 300 when the door 11 is closed.

As such, when the door 11 is closed, the bolt 303 of the guide rail 101 is inserted and locked into the hook opening 301 of the hook 300 to prevent the door 11 from being pushed away. When the door 11 is closed or opened, the hook 300 is vertically movable and rotatable about the pivot 295 passing through the slot 302 of the hook 300. Thus, even when foreign objects are accumulated in the groove 102, the door 11 is smoothly moved without friction between the hook 300 and the guide rail 101.

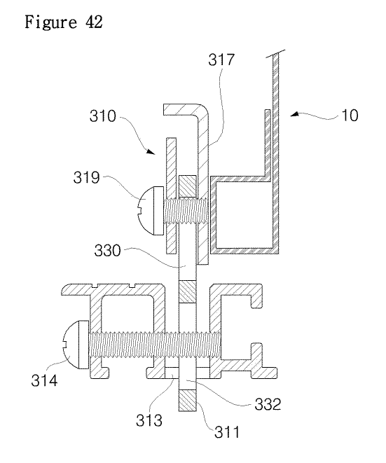

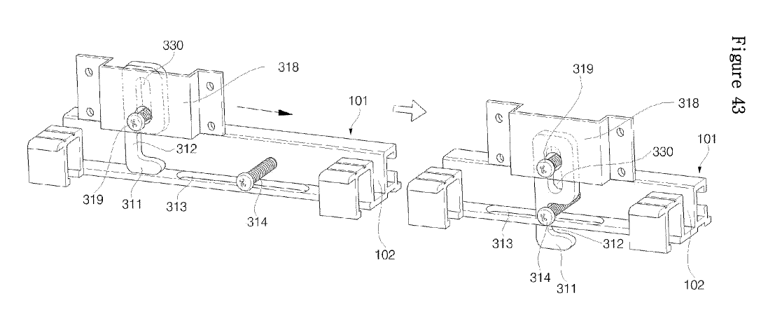

FIG. 41 is a perspective view illustrating a door system including a push-resistant device according to a thirteenth embodiment of the present invention, FIG. 42 is a cross-sectional view taken along line A-A′ of FIG. 41, and FIG. 43 is a schematic view illustrating an operation of a hook illustrated in FIG. 41.

Referring to FIG. 41, two doors 10 and 11 are moved horizontally to be closed or opened for an entrance of a floor. Push-resistant device 310 is disposed on a lower side of the door 10, and push-resistant device 320 is disposed on a lower side of the door 11. A hook 311 of the push-resistant device 310 includes a hook opening 312, and a hook 321 of the push-resistant device 320 includes a hook opening 322. The hook openings 312 and 322 are toward each other. That is, the hook openings 312 and 322 respectively formed in the hooks 311 and 321 are disposed in closing directions of the doors 10 and 11, respectively.

When the doors 10 and 11 are closed, the hooks 311 and 321 of the push-resistant devices 310 and 320 arrive at positions of a bottom of a groove 102 in a guide rail 101. Through holes 313 and 323 are formed in the positions of the bottom. Bolts 314 and 324 inserted into the hook openings 312 and 322 are disposed perpendicular to a longitudinal direction of the groove 102.

The push-resistant device 310 disposed on the lower side of the door 10 includes a supporting plate 317, an outer plate 318, a pivot 319, and the hook 311. Packets 315 and 316 for guide shoes are disposed on lower portions of both ends of the supporting plate 317, respectively. The outer plate 318 provided to the supporting plate 317 has bent both ends such that the outer plate 318 is spaced apart from the supporting plate 317. The pivot 319 includes a bolt coupled perpendicular to the supporting plate 317 through the outer plate 318. A slot 330 through which the pivot 319 passes is disposed in an upper portion of the hook 311. The hook opening 332, which is disposed in the closing direction of the door 10, is disposed in a lower portion of the hook 311.

When the doors 10 and 11 are closed, the hooks 311 and 322 arrive at the positions including the through holes 313 and 323. Thus, lower portions of the hooks 311 and 322 protrude from the bottom of the groove 102 through the through holes 313 and 323.

Referring to FIG. 42, during the door 10 is moved toward its closed position, the lower portion of the hook 311 is in contact with the bottom of the groove 102, thus the pivot 319 is adjacent to a lower end of the slot 330. However, when the door 10 arrives at the closed position, the lower portion of the hook 311 protrudes through the through hole 313 in the bottom of the groove 102 from the bottom of the groove 102, thus the pivot 319 is disposed in an upper end of the slot 330. As such, the pivot 319 is vertically moved within the slot 330 when the door 10 is closed. In here, the lower portion of the hook 311 protrudes downward through the through hole 313 from the bottom of the groove 102. Thus, push-resistant performance is more improved for the door 10.

Although the push-resistant devices are provided to the door, and the locking devices are provided to the guide rail, as described above, the push-resistant devices of the first, second, and ninth embodiments may be provided to the guide rail, and the locking devices coupled to the push-resistant devices of the first, second, and ninth embodiments may be provided to the door.

Also, although the above embodiments illustrates that the push-resistant device is provided to the door that is closed or opened for the entrance of the floor, it will be apparent to those skilled in the art that the push-resistant device may be provided to the cage door of the elevator.

While the present invention has been described in detail, it should be understood that various changes, substitutions and alterations can be made hereto without departing from the spirit and scope of the invention as defined by the appended claims.

What is claimed is:

1. A door system comprising: a door on which a push-resistant device is disposed; and a guide rail on which a locking device coupled to the push-resistant device is disposed, the guide rail forming a guide sill for the door,
wherein the push-resistant device includes a hook member protruding in a closing direction of the door,
the locking device includes an upper surface and side surfaces bent downward from both sides of the upper surface, and
the hook member is inserted into a space defined by the upper surface and the side surfaces when the door is closed.

2. The door system of claim 1, wherein one of the side surfaces is in contact with an outer side of the guide rail.

3. The door system of claim 1, wherein the guide rail comprises a groove disposed in a longitudinal direction thereof, and the locking device is disposed in the groove.

4. A door system comprising: a door on which a push-resistant device is disposed; and a guide rail on which a locking device coupled to the push-resistant device is disposed, the guide rail forming a guide sill for the door,
wherein the push-resistant device includes a hook member protruding in a closing direction of the door,
the locking device includes an upper plate, a groove insertion portion protruding downward from a bottom of the upper plate and inserted into a groove disposed in a longitudinal direction of the guide rail, and a vertical portion bent downward from an end of the upper plate and disposed on an outer side of an outer wall of the guide rail, and
the hook member is inserted and locked into a space defined by the upper plate, the vertical plate, and the outer side of the guide rail when the door is closed.

5. A door system comprising: a door on which a push-resistant device is disposed; and a guide rail on which a locking device coupled to the push-resistant device is disposed, the guide rail forming a guide sill for the door,
wherein the push-resistant device includes a hook member protruding in a closing direction of the door and having an insertion opening in a front end thereof, the insertion opening is disposed in the closing direction of the door,
the locking device includes a transverse member disposed perpendicular to a longitudinal direction of the guide rail, and
the transverse member is inserted into the insertion opening when the door is closed.

6. A push-resistant device disposed on a door closed or opened along a guide rail forming a sill, the push-resistant device comprising:
a coupling portion coupled to the door;
a connecting portion bent from an end of the coupling portion and extended toward an outer side distant from the door; and
a supporting portion extended downward from an end of the connecting portion and having a lower end parallel with an outer wall of the guide rail.

7. The push-resistant device of claim 6, wherein the supporting portion comprises an outward convex portion disposed between an upper portion and a lower portion thereof.

8. The push-resistant device of claim 6, wherein the outer wall of the guide rail comprises a protruding member protruding outward, the supporting portion comprises an insertion opening disposed in a closing direction of the door, and the protruding member is inserted into the insertion opening when the door is closed.

9. A door system comprising: a door on which a push-resistant device is disposed; and a guide rail on which a locking device coupled to the push-resistant device is disposed, the guide rail forming a guide sill for the door,
wherein the locking device is disposed in a groove disposed in a longitudinal direction of the guide rail and includes a housing having an opening, the opening is disposed in a portion of an upper surface of the housing in the longitudinal direction of the guide rail,
the push-resistant device includes a protruding portion protruding downward from a lower end of the door, and
the protruding portion is inserted into the opening when the door is closed.

10. A door system comprising: a door on which a push-resistant device is disposed; and a guide rail on which a locking device coupled to the push-resistant device is disposed, the guide rail forming a guide sill for the door,
wherein the push-resistant device includes a hook member protruding in a closing direction of the door,
the locking device includes a horizontal portion covering a groove disposed in a longitudinal direction of the guide rail, and
the hook member is inserted into a space defined by the groove and the horizontal portion when the door is closed.

11. A door system comprising: a door on which a push-resistant device is disposed; and a guide rail on which a locking device coupled to the push-resistant device is disposed, the guide rail forming a guide sill for the door,
wherein the push-resistant device includes a hook member protruding in a closing direction of the door,
the locking device includes: a moving stem vertically movable perpendicular to a bottom of a groove disposed in a longitudinal direction of the guide rail, the moving stem having a through hole through which a coupling bolt passing through the groove passes; and
a cover disposed on an upper end of the moving stem for covering the groove, and
the hook member is inserted into a space defined by the cover and the groove when the door is closed.

12. The door system of claim 11, wherein the through hole comprises a slot having a long axis in a longitudinal direction of the moving stem.

13. The door system of claim 11, wherein the bottom of the groove comprises a position at which the locking device is disposed, and a through hole is disposed in the position in a longitudinal direction of the groove.

14. A locking device disposed on a guide rail forming a guide sill for a door including a lower end on which a push-resistant device including a hook member is disposed, the hook member protruding from the push-resistant device, the locking device being coupled to the hook member when the door is closed, the locking device comprising:
a fixing bolt across a groove disposed in a longitudinal direction of the guide rail; and
a pipe inserted into the groove of the guide rail and having opened both ends, the pipe being vertically movable along the fixing bolt.

15. A push-resistant device disposed on a lower end of a door and movable along a guide rail forming a sill, the push resistant device comprising:
a pivot perpendicular to a moving direction of the door; and
a plate member including a through hole through which the pivot passes and a portion inserted into a groove of the guide rail.

16. The push-resistant device of claim 15, wherein the plate member has one of a circular shape and an oval shape.

17. The push-resistant device of claim 15, wherein the through hole comprises a slot having a long axis.

18. The push-resistant device of claim 15, wherein the plate member comprises a hook opening disposed in a closing direction of the door, the hook opening is disposed below the through hole, the guide rail comprises a transverse member in the groove, and the transverse member is inserted into the hook opening when the door is closed.

19. The push-resistant device of any one of claims 15 through 18, wherein the groove comprises a slot in a bottom thereof, at a position facing the pivot when the door is closed, and the slot is disposed in a longitudinal direction of the groove.

20. The push-resistant device of any one of claims 15 through 18, further comprising:
a first supporting plate disposed on a lower side of the door; and
a second supporting plate including a side portion parallel with and spaced apart from the first supporting plate, wherein the pivot passes through the first and second plates, and the plate member is disposed between the first and second plates.

21. The push-resistant device of claim 20, wherein one of the first and second plates comprises a packet-coupling portion for a guide shoe in a lower portion thereof, and a packet for the guide shoe is coupled to the packet-coupling portion.
